(19) United States
(12) Patent Application Publication
(10) Pub. No.: US 2008/0098109 A1
(43) Pub. Date: Apr. 24, 2008

(54) Incident resolution

(76) Inventors: Yassine Faihe, Champagnier (FR); Travis Tripp, Fort Collins, CO (US); Michael A. Clinger, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,045

(22) Filed: Oct. 20, 2006

(51) Int. Cl. G06F 15/173

(52) U.S. Cl. 709/224

(57) ABSTRACT

According to one embodiment of the present invention, there is provided apparatus for obtaining resolution information related to an incident report related to a monitored object in an IT infrastructure comprising: an incident report analyser for identifying an object identified in the report relevant to the incident and for identifying for that object an external resolution resource; an incident dispatcher for dispatching at least a portion of the received incident report to the identified external resolution resource; and an incident manager for receiving resolution information concerning the dispatched incident report from the external resource.

### FIELD OF THE INVENTION

The present invention relates generally to the field of information technology (IT), and more particularly, to IT support systems.

### BACKGROUND OF THE INVENTION

The use of IT management systems, especially in enterprise environments, is well known. For example, Hewlett-Packard supplies a suite of IT management systems referred to generally as HP OpenView that provide numerous monitoring, diagnostic and management functions.

Where such systems are used it is common for a monitoring system, such as HP OpenView Operations or Network Node Manager, to be used to monitor an object, such as a software application, infrastructure element, etc. If the monitoring system detects a problem with the monitored object the problem is generally signalled in a monitoring system console. The detected problem may also be turned into an incident and sent to a local incident tracking system, such as an internal IT service desk, to enable a human operator to analyse the problem and to take remediative action.

Typical internal IT service desks maintain a knowledge and solution base for particular software applications and infrastructure elements used in the IT environment and a solution to the problem may be available therein. However, if the internal knowledge and solution base does not contain any suitable solutions, the human operator typically has to access directly an external IT service desk proving support for the managed object, and to attempt to obtain a solution therefrom.

This is a manual process that needs data exchange back and forth between the management software administrator and the external service desk. The situation is further complicated by the fact that individual external service desks may use different systems, have different interfaces and generally may work in dissimilar ways.

Accordingly, one aim of the present invention is to overcome, or at least alleviate, at least some of the above-mentioned problems.

### SUMMARY OF THE INVENTION

According to a first aspect of the present invention, there is provided apparatus for obtaining resolution information related to an incident report related to a monitored object in an IT infrastructure. The apparatus comprises an incident report analyser for identifying an object identified in the report relevant to the incident and for identifying for that object an external resolution resource, an incident dispatcher for dispatching at least a portion of the received incident report to the identified external resolution resource, and an incident manager for receiving resolution information concerning the dispatched incident report from the external resource.

According to a second aspect of the present invention, there is provided a method for obtaining resolution information related to an incident report related to a monitored object in an IT infrastructure. The method comprises analysing the incident report to identify an object identified in the report relevant to the incident and for identifying for that object an external resolution resource, dispatching at least a portion of the received incident report to the identified external resolution resource, and receiving resolution information concerning the dispatched incident report from the external resource.

According to a third aspect of the present invention, there is provided machine-readable storage storing a program comprising instructions, when executed, for obtaining resolution information related to an incident report related to a monitored object in an IT infrastructure, the instructions being adapted to implement the steps of at least one of analysing the incident report to identify an object identified in the report relevant to the incident and for identifying for that object an external resolution resource, dispatching at least a portion of the received incident report to the identified external resolution resource, and receiving resolution information concerning the dispatched incident report from the external resource.

### BRIEF DESCRIPTION OF THE DRAWINGS

Embodiments of the present invention will now be described, by way of non-limiting example only, with reference to the accompanying diagrams, in which:

FIG. 1 is a block diagram of an IT support system according to the prior art;

FIG. 2 is a block diagram of a system according to an embodiment of the present invention; and

FIG. 3 is a flow diagram outlining example processing steps taken by the support system of FIG. 2.

### DETAILED DESCRIPTION OF THE PREFERRED EMBODIMENTS

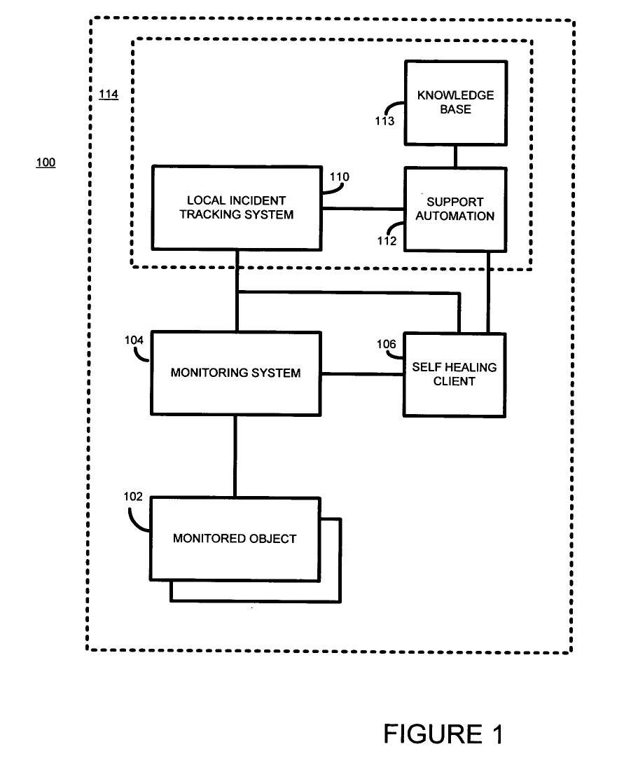

Referring now to FIG. 1, there is shown a block diagram of a system 100 according to the prior art.

The system 100 comprises one or more monitored objects 102. An object may be, for example, a software application, a network element (e.g. router), a database, and the like. The object is monitored by a monitoring system 104. The monitoring system 104 monitors the monitored object to determine the occurrence of an incident associated therewith. An incident may be, for example, when the monitored software application is determined to have a determinable state or status or has some other determinable characteristic or parameter, and may identify, for example, that application has crashed, that the monitored software application has a memory leak, a performance issue, etc. Where the monitored object is a network element, an incident may be, for example, that the monitored object has suffered a hardware failure, is unavailable, etc. Those skilled in the art will appreciate that any type of incident to be monitored for may be defined in the monitoring system for any given monitored object. An example of such a monitoring system in the field of IT system management is the Hewlett-Packard OpenView suite of applications.

In addition to the monitoring system 104, a self-healing client 106 is provided. The self-healing client 106 may be used to monitor the monitoring system and for resolving determined incidents in the monitoring system 104 itself, in a generally known manner.

If the monitoring system 104 determines that an incident has occurred with a monitored object, the monitoring system 104 signals the incident in its console. The monitoring system 104 also generates an incident report containing information relating, for example, to the nature of the incident, and may include managed object identifiers, software component identifiers, error messages, diagnostic data and the like. The incident report, in the form of an incident ticket, is then forwarded to a local incident tracking system 110.

The local incident tracking system 110 is arranged to forward the incident report to a support automation module 112. The elements 102, 104, 106, 110 and 112 are part of a local IT infrastructure 114 and may, for example, form part of a single enterprise's computer network.

The support automation module 112 attempts to automatically resolve the determined incident and, as is generally known, may access local support resources within the local IT infrastructure 114, such as a solution and knowledge base database 113 or other suitable resolution resource.

If the support automation system 112 is able to automatically determine a solution to the incident the support automation system 112 can apply the determined solution to the monitored object or other part of the local IT infrastructure 114. However, if the support automation module 112 is unable to provide a solution or information relating to a solution a human operator is alerted and the human operator is then charged with trying to resolve the incident in any appropriate manner.

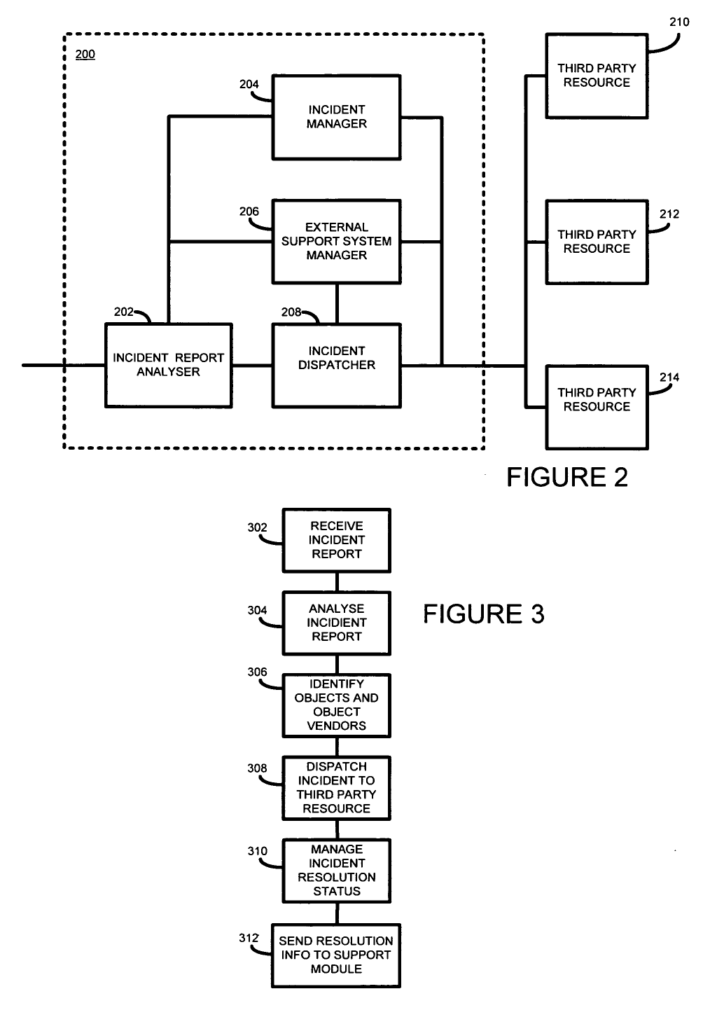

Referring now to FIG. 2 there is shown an external support automation system 200 according to an embodiment of the present invention. Further reference is made to FIG. 3, which is a block diagram showing example processing steps that may be taken by the external support automation system 200.

In the present embodiment the support automation module 112 of FIG. 1 is modified so as to forward incidents to the external support automation system 200. The incidents that the may be forwarded may be, for example, incidents that the support automation module 112 was unable to resolve using the resources of the local IT infrastructure 114. The support automation module 112 may additionally alert a human operator of an incident, in parallel with sending the incident to the external support automation system 200.

The external support system 200, as described in greater detail below, is responsible for resolving incidents through use of external resources, such as external vendor's helpdesks and online services 210, 212, 214.

The external support system 200 receives (step 302) incident reports at an incident report analyser 202. The incident report analyser 202 analyses (step 304) the incident reports received from the support automation module 112. The analysis determines (step 306) the identity (step 306) of which object or objects or components caused the incident report to be generated. For example, an incident report may detail that a problem was caused by a third party web browser used by the monitored object 102. The incident report may further detail that the problem with the web browser was caused by a plug-in web browser module supplied by a further third party.

Having determined the identity of the third party object or objects at the root of the incident, the vendor of the third party object is determined (step 306) and the incident report analyser 202 informs an external support system manager 206. The external support system manager 206 is configured with details of the third party resources 210, 212 and 214. Examples of third party resources include knowledge and solution databases, automated diagnosis services, case logging to the third party service desks and the like. The configuration details of the third party resource may be obtained in any suitable manner such as, for example, through manual configuration, through discovery of available third party resources, registration of the third party resources with the external support system 200.

If the external support system manager 206 has details of a suitable resource for the identified vendor the incident report analyser 202 sends a message to an incident manager 204. The incident manager 204 is responsible for managing the status of the incident with respect to both the local incident tracking system 110 and any of the external resources 210, 212 or 214.

For example, if the incident was additionally alerted, by the local incident tracking system 110, to a human operator as well as to the support automation module 112, if the human operator manages to obtain a satisfactory resolution of the incident prior to a resolution being obtained by external support system 200, the incident manager 204 is informed. The incident manager 204 then closes the incident with any external resources 210, 212, 214, previously informed of the incident.

Conversely, if an external resource 210, 212 or 214 is able to satisfactorily resolve the incident, this information is passed back to the support automation module 112 and the incident is closed on the external support system 200. The incident closure information is also fed back to the local incident tracking system 110, via the support automation module 112, so that the incident status may be closed or updated accordingly. The incident manager 204 is able to completely manage the status of the incident report, including escalation, updates, opening and closing, etc.

The incident report analyser 202 then forwards the incident report to an incident dispatcher 208.

The incident dispatcher 208 obtains details of the determined third party resource or resources to which the incident report should be sent. Where the incident report details multiple third party objects the incident report may be sent in its entirety, or the incident report may be pre-processed to remove any details deemed not relevant to any particular third party resource.

The external support system manager 206 may be configured with information relating to the format in which incident reports should be sent to any particular external resource. If the format of the received incident report is in a different format to that required by the determined third party resource then appropriate formatting of the incident report is performed. The required formatting information may be obtained, for example, through pre-configuration, through negotiation, through use of an XML based description language, and the like.

In an alternative embodiment all of the third party resources are arranged to use a standard incident report format, in which case no formatting is be required by the incident dispatcher 208.

The incident dispatcher 208 may additionally add or remove information from the incident report depending on particular circumstances. For example, the incident dispatcher may ‘anonymise’ the incident report by removing or modifying any information that may be used to determine the origin of the incident report.

The incident dispatcher 208 then dispatches (step 308) the incident report, to the determined third party resource.

The third party resource to which the incident report is sent may respond with status information relating thereto, and this is received by the incident manager 204 and processed accordingly (step 310). Such status information may be relayed back to the local incident tracking system 110 to enable the status of the incident to be tracked locally within the IT infrastructure 114.

If a third party resource is able to resolve the incident the resolution information provided by the third party resource is received by the incident manager 204. The incident manager 204 provides (step 312) at least a portion of the received resolution information back to the support automation module 112 which, depending on the nature of the resolution information can automatically apply the resolution information to resolve the incident. For example, the resolution information provided by a third party resource may be a software patch or update to be executed or to be applied to an object within the local IT infrastructure 114. Other examples of resolution information may be configuration data to be updated or applied, rebooting information, a link to an Internet based resource, or any other generally known resolution information.

If the local incident tracking system 110 determines that the resolution information successfully resolved the incident the incident is closed thereon, and the updated incident status is sent to the external support system 200 to enable the incident status to be closed on both the external support system 200 and on any other third party resources previously solicited by the external support system 200 during the resolution of the incident.

The incident report analyser may, depending on the received incident report, relate to problems with more than one third party object. In this case, the external support system 200 manages the resolution of the multiple issues in parallel, in a similar manner to that described above. For example, an incident report may comprise information relating to the computer system used, the monitored software object and one or more software plug-ins, each of which could be provided by different vendors. An incident could have been generated as a result of a problem with one or more of these components.

In a yet further embodiment when the incident report analyser 202 determines that an incident was generated as a result with multiple managed objects or multiple components in a single managed object, the incident report analyser 202 priorities the resolution of each problem, attempting to obtain resolution of each problem in a sequential manner. For example, where a plug-in caused a problem resolution is first sought with the vendor of the plug-in. If resolution is not obtained, resolution of the problem may be appropriately sough via the vendor of the identified computer system, and so on.

In an alternative embodiment the external support automation module 200 is provided internal to the local IT infrastructure 114 and functions in substantially the same manner as described above.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

1. Apparatus for obtaining resolution information related to an incident report related to a monitored object in an IT infrastructure comprising:
an incident report analyser for identifying an object identified in the report relevant to the incident and for identifying for that object an external resolution resource;
an incident dispatcher for dispatching at least a portion of the received incident report to the identified external resolution resource; and
an incident manager for receiving resolution information concerning the dispatched incident report from the external resource.

2. The apparatus of claim 1, wherein the incident report analyser is arranged for receiving an incident report from a support module of an IT infrastructure comprising the managed object, the support module being arranged for sending the incident report when the support module was unable to obtain resolution information from within the IT infrastructure, the incident manager being further arranged to send the received resolution information to the support module.

3. The apparatus of claim 1, further comprising an incident manager for managing the status of the dispatched incident report at the identified external resource.

4. The apparatus of claim 1, wherein the incident report analyser is arranged for identifying multiple objects in the report and for identifying one or more external resolution resources for each object, the incident dispatcher being further arranged for dispatching at least a portion of the received incident report to each of the identified external resolution resources.

5. The apparatus of claim 5, wherein the incident dispatcher is further arranged for prioritising the order in which the incident dispatcher sequentially dispatches the at least one portion of the incident report to each of the identified external resolution resources.

6. The system of claim 1, further comprising an incident report formatter for obtaining details of a format required by the identified resolution resource and for formatting the at least one portion into the required format prior to it being dispatched.

7. A method for obtaining resolution information related to an incident report related to a monitored object in an IT infrastructure comprising:
analysing the incident report to identify an object identified in the report relevant to the incident and for identifying for that object an external resolution resource;
dispatching at least a portion of the received incident report to the identified external resolution resource; and
receiving resolution information concerning the dispatched incident report from the external resource.

8. The method of claim 7, further comprising receiving the incident report from a support module of the IT infrastructure, the incident report being sent as a result of the support module being unable to obtain resolution information from within the IT infrastructure.

9. The method of claim 8, further comprising sending at least a portion of the received resolution information to the support module.

10. The method of claim 7, further comprising managing the status of the dispatched incident report.

11. The method of claim 7, wherein the step of analysing is arranged for identifying multiple objects in the report and for identifying one or more external resolution resources for each identified object, and wherein the step of dispatching is arranged for dispatching at least a portion of the received incident report to each of the identified external resolution resources.

12. The method of claim 4, further comprising prioritising the order in which the incident dispatcher sequentially dispatches the at least one portion of the incident report to each of the identified external resolution resources.

13. The method of claim 1, further comprising obtaining details of a format required by the identified resolution resource and for formatting the at least one portion into the required format prior to it being dispatched.

14. Machine-readable storage storing a program comprising instructions, when executed, for obtaining resolution information related to an incident report related to a monitored object in an IT infrastructure; the instructions being adapted to implement the steps of at least one of analysing the incident report to identify an object identified in the report relevant to the incident and for identifying for that object an external resolution resource; dispatching at least a portion of the received incident report to the identified external resolution resource; and receiving resolution information concerning the dispatched incident report from the external resource.
